(19) United States
(12) Patent Application Publication
(10) Pub. No.: US 2024/0235016 A1
(43) Pub. Date: Jul. 11, 2024

(54) A RADOME FOR ENCASING AN ANTENNA SYSTEM

(71) Applicant: THRANE & THRANE A/S, Kongens Lyngby (DK)

(72) Inventors: Ross BOX, Kongens Lyngby (DK); Mads ALFREDSEN, Kongens Lyngby (DK); Michael Leon SCHÖNHOLZER, Kongens Lyngby (DK)

(73) Assignee: THRANE & THRANE A/S, Kongens Lyngby (DK)

(21) Appl. No.: 18/559,540

(22) PCT Filed: May 12, 2022
(86) PCT No.: PCT/EP2022/062951

§ 371 Date: Nov. 7, 2023

(30) Foreign Application Priority Data
May 12, 2021 (EP) 21173667.3

(51) Int. Cl. H01Q 1/42; H01Q 1/34; H01Q 15/14

(52) U.S. Cl. CPC H01Q 1/424; H01Q 1/34; H01Q 15/141

(57) ABSTRACT

A method of manufacturing a radome for encasing an antenna system, preferably for marine use, is described. The method comprising the steps of: providing one or more moulds for manufacturing a structural main body of the radome or parts of the structural main body of the radome, each of the one or more moulds comprising a mould cavity, injecting a foamed polymer material into the mould cavity or mould cavities of the one or more moulds to form the structural main body of the radome or parts of the structural main body of the radome, and optionally connecting the parts of the structural main body of the radome to form the main body of the radome. Further, a radome for encasing an antenna system, preferably for marine use, is described. The radome comprises a structural main body, which is made from a foamed polymer material.

### FIELD OF THE INVENTION

The present invention relates to a radome for encasing an antenna system, in particular for marine use, a communication system comprising such a radome and a method for manufacturing such a radome.

### BACKGROUND OF THE INVENTION

The term “radome” is derived from an abbreviation of the words “radar” and “dome” and in general refers to a structure that protects a device, such as an antenna system, that transmits and/or receives electromagnetic radiation.

A radome is a critical part of a communication system because its properties can greatly influence the effectiveness of the communication system and must be compatible with the specific properties of the communication system. In general, the radome needs to be designed so as to have electromagnetic radiation transparency in the required communication bands and needs to have structural integrity as well as being protected from environmental influences. The latter is particularly relevant for radomes for marine use. In this regard a thick-walled radome has advantages in terms of structural integrity but may have detrimental effect on the transparency of electromagnetic radiation in the required communication bands. On the other hand, a thin-walled design may have advantages for the electromagnetic radiation transparency but may entail increased maintenance cost in servicing the radome.

Modern radomes are often made as a fibre-reinforced structure and sometimes as a sandwich construction. Such radomes have high structural integrity but can be complicated and expensive to manufacture. Further, the radomes must be tuned to specific frequency bands or ranges.

### SUMMARY OF THE INVENTION

It is an object of the invention to obtain a radome for encasing an antenna system for marine use as well as obtaining a communication system with such a radome, and a method of manufacturing such a radome, which overcome or ameliorate at least one of the disadvantages of the prior art or which provide a useful alternative. In particular, it is an object of the invention to provide a radome that provides an improved trade-off between the aforementioned design requirements.

According to a first aspect, this is obtained by a communication system, preferably for marine use, comprising: a radome comprising a structural main body, which is made of a foamed polymer material, the radome further comprising an open proximal end, a platform connected to the open proximal end of the radome, and an antenna system mounted on. Preferably, the radome and platform are configured such that the radome encases the antenna system. The platform itself may be substantially plane or flat.

According to a second aspect, this is obtained by a radome for encasing an antenna system for marine use, wherein the radome comprises a structural main body, which is made from a foamed polymer material. Again, the radome preferably has a shape that allows it to encase an antenna system.

By letting the main body and hence the structural part of the radome being made out of a polymer material, the radome can be manufactured cost-effectively and the radome be made in a material that is transparent to radio waves in the required frequency bands. The term “transparent” as used herein means that an acceptable portion (e.g., a majority) of the radio waves may be transmitted through the structural main body and being particularly tuned to the required frequency bands.

It is clear that the structural main body constitutes the structural part of the radome, i.e., without fibre-reinforcement layers and/or a sandwich construction. Further, the main body may be formed by a single integrated part made of a foamed polymer or be assembled from two or more parts made of a foamed polymer.

According to a second aspect, the invention provides a communication system comprising a radome according to the first aspect, the radome comprising an open proximal end, a platform connected to the open proximal end of the radome, and an antenna system mounted on the platform.

According to a third aspect, the invention provides a kit of parts comprising a plurality of separately manufactured structural main body parts made from a foamed polymer material, and which can be connected to form a structural main body of a radome according to the first aspect.

According to a fourth aspect, the invention provides a method of manufacturing a radome for encasing an antenna system for marine use, the method comprising the steps of: providing one or more moulds for manufacturing a structural main body of the radome or parts of the structural main body of the radome, each of the one or more moulds comprising a mould cavity, injecting a foamed polymer material into the mould cavity or mould cavities of the one or more moulds to form the structural main body of the radome or parts of the structural main body of the radome, and optionally connecting the parts of the structural main body of the radome to form the main body of the radome.

This provides a particular advantageous method of manufacturing a radome, which is both simple and cost-effective to manufacture and provides advantages for transparency of the required frequency bands used for communication systems having such a radome.

According to a fifth aspect, the invention provides a method of manufacturing a communication system, the method comprising the steps of: manufacturing a radome according to the first aspect, providing a platform, mounting an antenna system on the platform, and connecting the platform to an open end of the radome.

In the following a number of preferred embodiments are described. The embodiments may relate to any of the first, second, third, fourth and fifth aspects.

The communication system may in principle be a one-way communication system. However, in a preferred embodiment, the communication system is configured for two-way communication.

According to a preferred embodiment, the foamed polymer material is expanded polypropylene. Polypropylene has been found as a material that is both cost-effective for the manufacture of the structural main body and which in addition has the right properties for the structural part of the radome with electromagnetic radiation transparency within the required frequencies.

The foamed polymer material, e.g., the expanded polypropylene, may advantageously be a closed-cell foamed polymer material. The closed-cell foamed material may for instance be made from beads that are pre-expanded before the formation of the structural main body, e.g., by steam chest moulding or irradiating with microwaves or the like.

In a preferred embodiment, the structural main body has a shape with a proximal part which is substantially cylindrical or conical, and a distal part that is substantially spherical. The proximal part may be proximal to an open end of the radome. Accordingly, the radome is seen to be of the shape that encases antenna systems, e.g., a parabolic antenna, that are often used for marine communication systems. However, in principle, the radome can also have a fully spherical shape.

Preferably, the structural main body is made from a plurality of separately manufactured parts that are subsequently connected to form the structural main body. Such a structural main body is easier to manufacture and to demould to the correct shape, in particular if the radome is of the aforementioned shape with a cylindrical and spherical part. Accordingly, the structural main body of the radome may be made from two or more separately manufactured structural main body parts, e.g., two parts, three parts, four parts, or five parts.

In a preferred embodiment, the plurality of separately manufactured parts is connected by plastic welding, preferably by non-contact heating of connecting surfaces of the plurality of separately manufactured parts. Plastic welding, and in particular by non-contact heating, has been found to have advantages over for instance glue bonds for the structural integrity of the structural main body. The separately manufactured parts may advantageously be connected via plastic welding seams that have a thickness of 0.10-1.00 mm, and preferably 0.20 mm-0.50 mm.

The structural main body may advantageously be made from two half shells. This provides a particularly simple way of manufacturing the separately manufactured parts and subsequent assembly or connection of the parts. Further, if the radome has a rotational symmetry design, the two parts may be made in the same mould.

In another advantageous embodiment, a proximal part is made from a plurality of first parts, and at least a part of the distal part is made from a second part. This may for instance be related to the aforementioned shape with a proximal part and distal, spherical part. This embodiment provides another simple way of manufacturing the separately manufactured parts and subsequent assembly or connection of the parts. The proximal part may be made of for instance two or four parts. By having additional parts, the separate parts may be easier to manufacture. However, this increases the number of seams or bonds in the radome, which may influence the electromagnetic radiation transparency.

According to a preferred embodiment, an exterior surface of the structural main body is coated with a protective coating, the protective coating forming an exterior surface of the radome. Preferably, an interior surface of the structural main body is not provided with a coating. By having only one side of the main body coated, it is ensured that the coating does not provide internal reflections that may interfere with the communication bands. Accordingly, it is seen that the radome in a preferred embodiment consists only of a structural main body made of a foamed polymer, preferably expanded polypropylene, and a protective coating on an exterior side of the structural main body. The protective coating may for instance comprise an outdoor grade two-component polyurethane.

In another preferred embodiment, the protective coating is made from two or three layers, e.g., comprising an adhesion promoter layer, a primer (or filler) layer, and a layer of protective paint. The primer or filler layer may for instance be a high-solids two-component epoxy primer, and the protective paint be a high-solids two-component polyurethane gloss topcoat.

Preferably, the protective coating is made from at least two layers comprising a primer layer, and a topcoat layer, e.g., protective paint, combined with at least one of: surface activation of the structural main body, and an adhesion promoter layer. The surface activation of the structural main body is preferably chosen from the group of: plasma treating, corona treating, and flame treating. The surface activation increases surface energy, which in turn promotes the adhesion of the subsequently applied layers. Surface treatment, such as sanding, will also improve the mechanical bonding and increase the surface energy. The adhesion promoter may be any chemical formulation that may increase adhesion.

In a preferred embodiment, the protective coating, e.g., the protective paint, comprises a material chosen from the group of: polyurethane, and acrylic paint. The use of epoxy and silicone is also contemplated. In general, the coating should have appropriate specifications and properties for long term harsh environment and UV protection.

The paint may advantageously comprise colour pigments, such as TiO₂, which may also add protection.

In another embodiment, the structural main body is made from a UV stable expanded polypropylene. This embodiment has the advantage that no additional protective coating is needed.

In a preferred embodiment of the radome, the protective coating has a thickness of 0.01-0.5 mm, preferably less than 0.3 mm. This together with the structural main body provides an efficient trade-off between having excellent structural integrity and resistance to the environment while having excellent properties in relation to electromagnetic radiation transparency for the required frequency bands.

In another embodiment, the protective coating is made from a protective film, such as a thermoplastic film. The protective coating can also be made from a pre-moulded skin.

Preferably, the structural main body and the protective coating provide acceptable performance for radio waves in the range 0.5 GHz-120 GHz, preferably in the range 5-100 GHz, and more preferably in the range 10-45 GHz. For the coating, this transparency may be obtained from the aforementioned materials and layer thickness. In particular, the main body and the protective coating may be transparent to radio waves in the L band (1-2 GHz), the S band (2-4 GHz), the C band (4-8 GHz), the X band (8-12GHz), the Ku band (12-18 GHz), the K band (18-27 GHz), the Ka band (27-40 GHz), the V band (40-75 GHz), and the W band (75-110). Preferably, the structural main body and the protective coating provide acceptable performance for radio waves in the Ku band, the K band, and the Ka band.

According to a preferred embodiment, the structural main body has a thickness of 0.50 cm-10 cm, preferably 1.00 cm -5 cm.

In another preferred embodiment, the structural main body has a maximum outer dimension (e.g., a diameter), and wherein ratio between the thickness of the structural main body and the maximum outer diameter is between 1:25 and 1:200, preferably between 1:50 and 1:100.

Preferably, the radome has a maximum outer dimension, such as a diameter of 0.50-4.0 m, preferably 0.5-3.0, and more preferably 0.50-2.0 m.

In yet another preferred embodiment, the foamed polymer material of the main structural part has a density of 50-200 g/l.

In one embodiment, the radome comprises a thickened portion at a proximal end of the structural main body. The thickened part may be integrated with the structural main body, or it can be a separately mounted piece that is attached to an interior side of the structural main body. The thickened portion may comprise a plurality of fastening members, the plurality of fastening members being configured to connect to attachment members for attaching a platform carrying the antenna system to the proximal end of the radome. The fastening members may for instance be embedded in the thickened part of the radome. This provides a simple method of connecting parts of a communication system comprising the radome. In an advantageous embodiment, the fastening members are made of a polymer material or a fibre-reinforced polymer material. In another advantageous embodiment, the fastening members are friction welded into the thickened part of the radome. This provides a particularly simple method of providing a simple and strong connection together with the main body made of a foamed polymer material, preferably expanded polypropylene.

In an advantageous embodiment for the communication system, the platform is connected to fastening members arranged at the open proximal end of the radome via self-threading screws.

As previously mentioned, it is recognised that the radome may also be provided as a kit of parts that is assembled at a later point, e.g., near the site of use. The kit of parts may have advantages in terms of transport because the shell parts of the radome may be stacked on top of each other, whereby the parts take up much less transport space than if the radomes or communication systems are transported in assembled conditions.

In a preferred embodiment of the method, the foamed polymer material comprises beads of pre-expanded polypropylene and the beads are injected into the one or more moulds so as to form the structure main body or parts of the structural main body of the radome as a closed-cell foamed polymer.

In another preferred embodiment, the method comprises the steps of: manufacturing a plurality of separate structural main body parts made from foamed polymer, and connecting the separate structural main body parts by plastic welding to form the structural main body of the radome. As previously mentioned, such a method has been found to have advantages over for instance glue bonds for the structural integrity of the structural main body. The separate structural main body parts may advantageously be connected to each other by non-contact heating of connecting surfaces. Non-contact heating has been found to have advantages over other types of plastic welding to get thin weld seams that do not interfere with the electromagnetic radiation.

In yet another preferred embodiment, the method comprises the steps of: arranging a heating element near at least one connecting surface of a first structural main body part, pressing the at least one connecting surface of the first structural main body part against a corresponding connecting surface of a second structural main body part along a first plastic welding seam, and cooling or waiting for the first plastic welding seam to cool so as to connect the first structural main body part to the second structural main body part, and optionally repeating the steps to form the structural main body. Preferably, the corresponding connecting surface of the second structural main body part is also heated before the two parts are pressed together. This provides a particular simple method of providing the non-contact heating that in turn provides plastic welding seams of the required quality.

In another preferred embodiment, the method comprises the step of applying a protective coating onto an exterior surface of the main body. The step of applying a protective coating onto an external surface of the main body advantageously comprises applying a primer layer, and applying a topcoat layer, e.g., protective pain, such as polyurethane and acrylic paint. The use of epoxy and silicone is also contemplated. Prior to applying the primer layer, an adhesion promoter layer may be applied on the exterior surface of the structural main body. Alternatively or in addition hereto, the exterior surface of the structural main body may be surface activated. This may be done by for instance plasma treating, corona treating, and flame treating the exterior surface of the structural main body.

The exterior surface of the main body may advantageously be surface abraded before applying the protective coating, and the exterior surface is cleaned after the step of mechanically abrading the exterior surface of the main body. Similarly, the primer layer may be surface abraded before applying the topcoat layer. All these steps will improve the adhesion of the protective coating and in turn improve the protection coating of the radome.

### BRIEF DESCRIPTION OF THE FIGURES

The invention is explained in detail below with reference to embodiments shown in the drawings, in which:

FIGS. 1a, 1b, and 1c show a first embodiment of a radome for encasing an antenna system for marine use;

FIG. 2 shows a second embodiment of a radome for encasing an antenna system for marine use;

FIG. 3 shows a third embodiment of a radome for encasing an antenna system for marine use;

FIGS. 4a, 4b, and 4c show a fourth embodiment of a radome for encasing an antenna system for marine use;

FIG. 5 shows a first embodiment of a communication system;

FIGS. 6a and 6b show second and third embodiments of a communication system;

FIG. 7 shows a fourth embodiment of a communication system;

FIG. 8 illustrates a method of manufacturing a radome for encasing an antenna system for marine use;

FIG. 9 illustrates a method of manufacturing a communication system, and

FIG. 10 illustrates the sub-steps in one of the steps of manufacturing the radome.

### DETAILED DESCRIPTION OF THE INVENTION

In the following, a number of exemplary embodiments are described in order to understand the invention. Throughout the description, like numerals refer to like parts in the various embodiments.

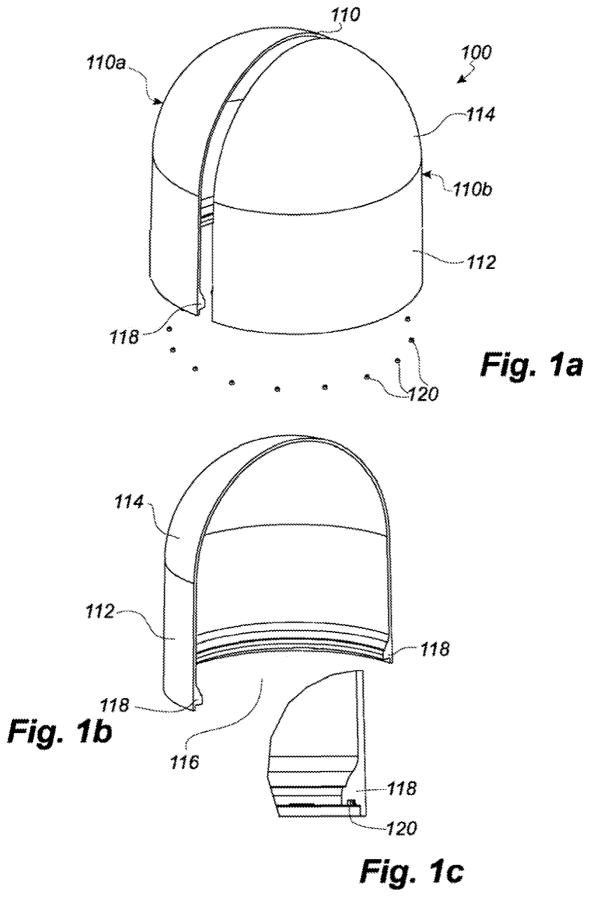

FIGS. 1a, 1b, and 1c illustrate a radome 100 according to a first embodiment. The radome 100 comprises a structural main body 110, which is made from a foamed polymer material. The structural main body is made from two separately manufactured main body parts 110a, 110b that are subsequently connected to form the structural main body 110. The structural main body 110 or separately manufactured main body parts 110a, 110b are manufactured as unitary part(s) in a single material, and thus differ from other radomes, where the radome is made from a sandwich construction with a foam layer.

As shown, the structural main body 110 may have a shape with a proximal part 112 at an open end 116 of the radome 110, wherein at least an exterior surface of the structural main body 110 is substantially cylindrical or conical, and a distal part 114, wherein at least an exterior surface of the distal part 114 is substantially spherical. Accordingly, the radome is seen to be of the shape that may encase an antenna system, e.g., a parabolic antenna, which is a type that is often used for marine communication systems. However, in principle, the radome can also have a fully spherical shape.

In the shown embodiment, the two separately manufactured main body parts 110a, 110b are manufactured as two identical half shells that are subsequently connected to form the structural main body 110. This provides a particularly simple way of manufacturing the separately manufactured parts 100a, 110b and subsequent assembly or connection of the parts 100a, 110b. Further, if the structural main body 110 of the radome 100 has a rotational symmetry design as shown in the first embodiment, the two parts 100a, 110b may be made in the same mould.

By manufacturing the structural main body 110 as separately manufactured parts that are assembled, it is simpler and more cost-effective to manufacture the separately manufactured parts to the correct shape, which is particularly beneficial for radomes of the shape in the first embodiment.

By letting the main body and hence the structural part of the radome being made out of a polymer material, the radome can be manufactured cost-effectively and the radome be made in a material that has low loss characteristics to radio waves in the required frequency bands. Further, by reducing the number of layers, interference can be kept minimal. Thus, the construction has advantages in both manufacturing, cost, and performance. The foamed polymer material is preferably expanded polypropylene. Polypropylene has been found as a material that is both cost-effective for the manufacture of the structural main body and which in addition has the right properties for the structural part of the radome with electromagnetic radiation transparency within the required frequencies. The foamed polymer material, e.g., the expanded polypropylene, may advantageously be a closed-cell foamed polymer material. The closed-cell foamed material may for instance be made from beads that are pre-expanded before the formation of the structural main body, e.g., by steam chest moulding, irradiating with microwaves, or the like. The plurality of separately manufactured parts may advantageously be connected by plastic welding, preferably by non-contact heating of connecting surfaces of the plurality of separately manufactured parts. Plastic welding, and in particular by non-contact heating, has been found to have advantages over for instance glue bonds for the structural integrity of the structural main body. The separately manufactured parts may advantageously be connected via plastic welding seams that have a thickness of 0.10-1.00 mm, and preferably 0.20 mm-0.50 mm.

The structural main body 110 may advantageously have a thickness of 0.50 cm-10 cm, preferably 1.00 cm-5 cm. Further, the radome may have a maximum outer dimension, such as a diameter of 0.50-2.0 m. Alternatively, the structural main body has a maximum outer diameter, wherein the ratio between the thickness of the structural main body and the maximum outer diameter is between 1:25 and 1:200, preferably between 1:50 and 1:100. Further, the foamed polymer material of the structural main body 110 has a density of 50-200 g/l. Radomes with such dimensioning and design have been found to be particularly advantageous for the performance of a communication system, in particular for marine use, utilising such a radome.

In the above, it has been described that it is the structural main body 110 that may be designed according to given specifications. However, it is recognised that it may be only at least a majority or only the part of the structural main body 110 that needs to be transparent to the electromagnetic radiation, which may be dimensioned accordingly.

As shown in the first embodiment, the structural main body 110 may comprise a thickened portion 118 at the proximal end 112 of the structural main body 110. The thickened part 118 may be integrated with the structural main body 110 as shown in the first embodiment.

The thickened portion 118 may comprise a plurality of fastening members 120, the plurality of fastening members 120 being configured to connect to attachment members for attaching a platform carrying the antenna system to the proximal end 112 of the radome 100. The fastening members 120 may for instance be embedded in the thickened part 118 of the main structural part 110. This provides a simple method of connecting parts of a communication system comprising the radome 100. The fastening members 120 may be made of a polymer material or a fibre-reinforced polymer material. The fastening members 120 may advantageously be friction welded into the thickened part 118 of the structural main body 110. This provides a particularly simple method of providing a simple and strong connection together with the structural main body 110 made of a foamed polymer material, preferably expanded polypropylene.

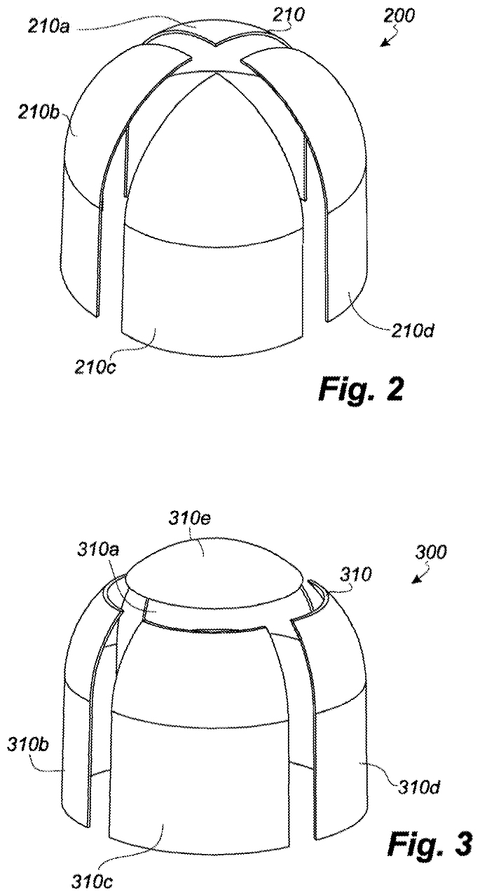

FIG. 2 shows a second embodiment of a radome 200 for encasing an antenna system for marine use. In the shown embodiment, the structural main body 210 is made up of four different pre-manufactured parts 210a, 210b, 210c, and 210d. Similar to the first embodiment, if the radome 200 has a rotational symmetry design, the four parts 210a, 210b, 210c, and 210d may be manufactured in the same mould. In the shown embodiment, each of the four parts 210a, 210b, 210c, and 210d may form the cylindrical, proximal part and the spherical, distal part of the structural main body 210.

FIG. 3 shows a third embodiment of a radome 300 for encasing an antenna system for marine use. In the shown embodiment, the structural main body 310 is made up of five different pre-manufactured parts 310a, 310b, 310c, 310d, and 310e. In the shown embodiment, four of the parts 310a, 310b, 310c, and 310d may form the cylindrical, proximal part and part of the spherical, distal part of the structural main body 310, whereas the fifth part 310e form a cap part of the spherical, distal part of the structural main body 310. Similar to the first embodiment and second embodiment, if the radome 300 has a rotational symmetry design, the four first parts 310a, 310b, 310c, and 310d may be manufactured in the same mould.

From the already shown embodiments, it is clear that it is also possible to provide the radome as a kit of parts comprising a plurality of separately manufactured structural main body parts made from a foamed polymer material, and which can be connected to form a structural main body of a radome. The kit of parts may have advantages in terms of transport, because the shell parts of the radome may be stacked on top of each other, whereby the parts take up much less transport space than if the radomes or communications systems are transported in assembled conditions.

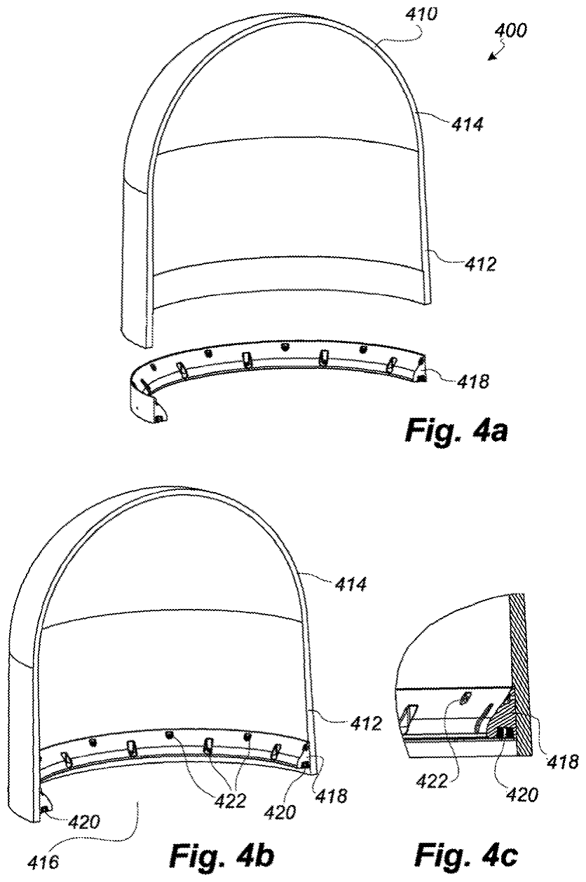

FIG. 4 shows a fourth embodiment of a radome 400 for encasing an antenna system for marine use, wherein like numerals refer to like parts of the first embodiment. The radome 400 comprises a structural main body 410, which is made from a foamed polymer material. As shown, the structural main body 410 may have a shape with a proximal part 412 at an open end 416 of the radome 410, wherein at least an exterior surface of the structural main body 410 is substantially cylindrical or conical, and a distal part 414, wherein at least an exterior surface of the distal part 414 is substantially spherical. Accordingly, the radome is seen to be of the shape that may encase an antenna system, e.g., a parabolic antenna, which is a type that is often used for marine communication systems. However, in principle, the radome can also have a fully spherical shape. The radome 400 also has a thickened part 418 near the open end 416 of the radome 400. However, in contrast to the first embodiment, the thickened part 418 is provided as a separately manufactured part that is attached to an interior surface on the structural main body 410. The separately manufactured part 418 may be attached to the interior surface of the structural main body 410 via connecting members 422. The thickened portion 418 may comprise a plurality of fastening members 420, the plurality of fastening members 120 being configured to connect to attachment members for attaching a platform carrying the antenna system to the proximal end 412 of the radome 400. Otherwise, the dimensioning and design may be the same as described for the first embodiment.

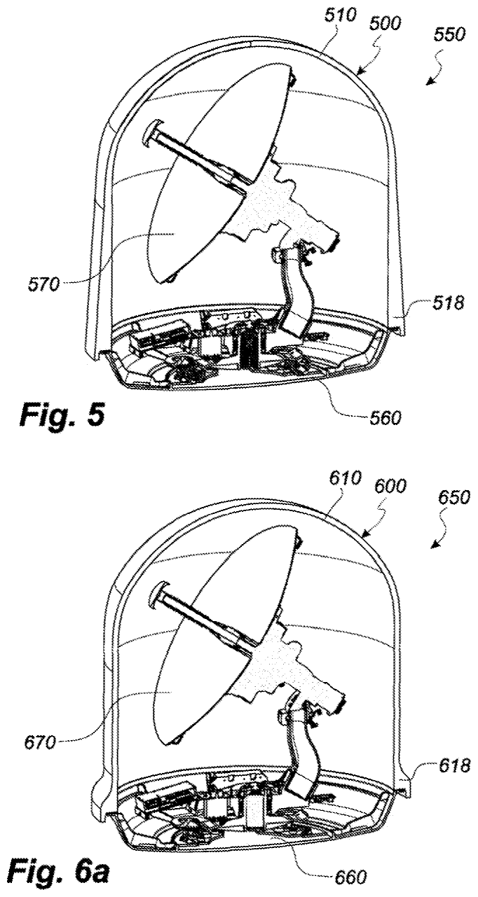

FIG. 5 shows a cutaway perspective view of a communication system 550. The communication system comprises a radome 500 with a structural main body 510. The structural main body 510 has a thickened part. A platform 560 supporting an antenna system 570 is connected to an open end of the radome 500, e.g., via fastening members integrated (not shown) in the thickened part 518 of the radome and screws, such as self-cutting screws, inserted through holes in the platform 560 and cutting into the fastening members. In the shown embodiment, the thickness of the structural main body 510 gradually thickens from a distal part of the radome 500 towards a proximal end of the radome 500. Otherwise, the dimensioning and design of the radome 500 may be the same as described for the previously described embodiments.

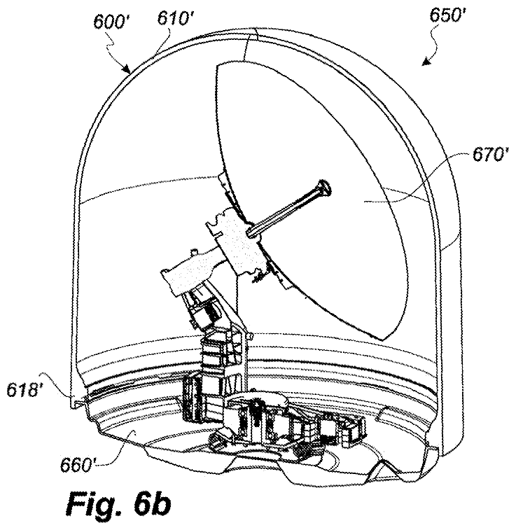

FIG. 6a shows a cutaway perspective view a second embodiment of a communication system 650. The communication system comprises a radome 600 with a structural main body 610. The structural main body 610 has a thickened part 618. A platform 660 supporting an antenna system 670 is connected to an open end of the radome 600, e.g., via fastening members integrated (not shown) in the thickened part 618 of the radome and screws, such as self-cutting screws, inserted through holes in the platform 660 and cutting into the fastening members. In the shown embodiment, the structural main body 610 is only thickened at the proximal end of the radome 600 and has a similar design to that of the first embodiment of the radome shown in FIG. 1. The dimensioning and design of the radome 600 may be the same as described for the previously described embodiments.

FIG. 6b shows a cutaway perspective view a third embodiment of a communication system 650′. The communication system comprises a radome 600′ with a structural main body 610′. The structural main body 610′ has a thickened part 618′. A platform 660′ supporting an antenna system 670′ is connected to an open end of the radome 600′, e.g., via fastening members integrated (not shown) in the thickened part 618′ of the radome and screws, such as self-cutting screws, inserted through holes in the platform 660′ and cutting into the fastening members. In the shown embodiment, the structural main body 610′ is only thickened at the proximal end of the radome 600′ and has a similar design to that of the first embodiment of the radome shown in FIG. 1. The dimensioning and design of the radome 600′ may be the same as described for the previously described embodiments. The difference between the second and third embodiments is inter alia that the thickened part protrudes outwards from the structural main body in the second embodiments, whereas it protrudes inwards in the third embodiment.

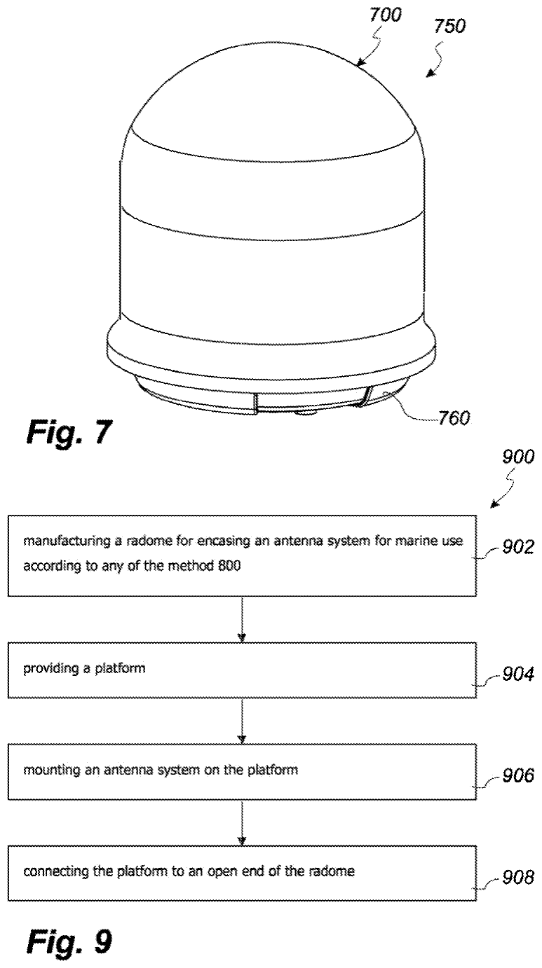

FIG. 7 shows a perspective view of a fourth embodiment of a communication system 750 and illustrates the parts encasing the antenna system. The communication comprises a radome 700 and a platform 760 connected to an open end of the radome, the platform 760 supporting an antenna system (not shown) encased in the radome 700.

In the following with reference to FIG. 8, a method 800 of manufacturing a radome for encasing an antenna system for marine use is described. In a first step 802, one or more moulds for manufacturing a structural main body of the radome or parts of the structural main body of the radome is provided. Each of the one or more moulds comprises a mould cavity. In a second step 804, a foamed polymer material is injected into the mould cavity or mould cavities of the one or more moulds to form the structural main body of the radome or parts of the structural main body of the radome. The foamed polymer material may, as described in step 806, comprise beads of pre-expanded polypropylene and the beads are injected into the one or more moulds so as to form the structure main body or parts of the structural main body of the radome as a closed-cell foamed polymer.

If the structural main body is made from a plurality of parts, the parts are as described in step 808 connected to form the main body of the radome. As described in step 810, the separate structural main body parts may be connected by plastic welding to form the structural main body of the radome. In an advantageous embodiment described in step 812, the plastic welding is obtained by non-contact heating of connecting surfaces of the plurality of separately manufactured parts, e.g., by arranging a heating element near at least one connecting surface of a first structural main body part and preferably also a heating element near at least a corresponding surface of a second structural main body part. In a subsequent step 814, the at least one connecting surface of the first structural main body part is pressed against a corresponding connecting surface of a second structural main body part along a first plastic welding seam. Finally, in step 816, the first plastic welding seam is cooled, alternatively waiting for the seam to cool, so as to connect the first structural main body part to the second structural main body part. If the structural main body is made up of additional parts, the above steps may be repeated.

The use of plastic welding, and in particular by non-contact heating, for connecting the separately manufactured parts has been found to have advantages over for instance glue bonds . The separately manufactured parts may advantageously be connected via plastic welding seams that have a thickness of 0.10-1.00 mm, and preferably 0.20 mm-0.50 mm.

According to a preferred embodiment, an exterior surface of the structural main body is coated with a protective coating, the protective coating forming an exterior surface of the radome. This is described in step 818 of FIG. 8. By having only one side of the main body coated, it is ensured that the coating does not inadvertently enhance internal reflections that may interfere with the communication bands. Accordingly, it is seen that the radome in a preferred embodiment consists only of a structural main body made of a foamed polymer, preferably expanded polypropylene, and a protective coating on an exterior side of the structural main body.

The protective coating is preferably made from two or three layers, e.g., comprising an adhesion promoter layer, a primer layer, and a layer of protective paint. The protective coating or the protective paint may comprise a material chosen from the group of: polyurethane, and acrylic paint. In general, the coating should be appropriate for long term harsh environment and UV protection. The paint may advantageously comprise colour pigments, such as TiO₂, which may also add protection. In a preferred embodiment of the radome, the protective coating has a thickness of 0.01-0.5 mm, preferably less than 0.3 mm. This together with the structural main body provides an efficient trade-off between having excellent structural integrity and resistance to the environment while having excellent properties in relation to electromagnetic radiation transparency for the required frequency bands. It is also possible to use UV stable expanded polypropylene for the structural main body, in which case the additional protective coating is not needed.

Preferably, the structural main body and the protective coating provide acceptable performance for radio waves in the range 0.5 GHz-120 GHz, preferably in the range 5-100 GHz, and more preferably in the range 10-45 GHz. For the coating, this transparency may be obtained from the aforementioned materials and layer thickness.

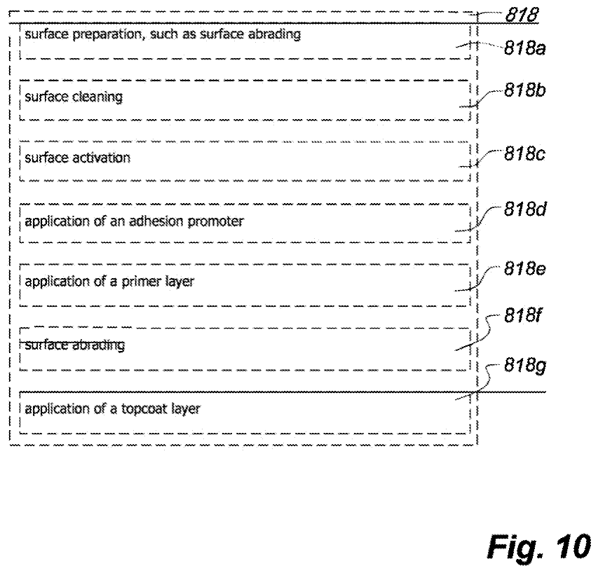

FIG. 10 illustrates examples of providing the protective coating to the exterior surface of the radome, i.e. step 818 of the method illustrated in FIG. 8. In a first optional step 818a, the exterior surface of the radome is prepared, for instance by mechanical abrading the surface, e.g. by sanding the exterior surface. Other types of abrasion methods may also be used, such as sand blasting or glass blasting the surface. This provides a roughened surface which may promote adhesion. In a subsequent step 818b, the exterior surface is cleaned to for instance remove the dust from the surface abrading. This may for instance be done by blowing air onto the surface and/or cleaning the surface with a solvent wipe or the like. In a following step, the surface may be activated (step 818c), or an adhesion promoter may be applied to the exterior surface of the radome (step 818d), or both (step 818c and step 818d). The adhesion promoter may for instance be a spray application of a suitable chemical formulation. The surface activation entails increasing the surface energy, which for instance may be carried out by plasma treatment, corona treatment, or flame treatment of the exterior surface of the radome. In a subsequent step 818e, a primer layer is applied. Subsequently, in step 818f, the surface is optionally once again surface abraded. In a final step 818g, a topcoat layer is applied.

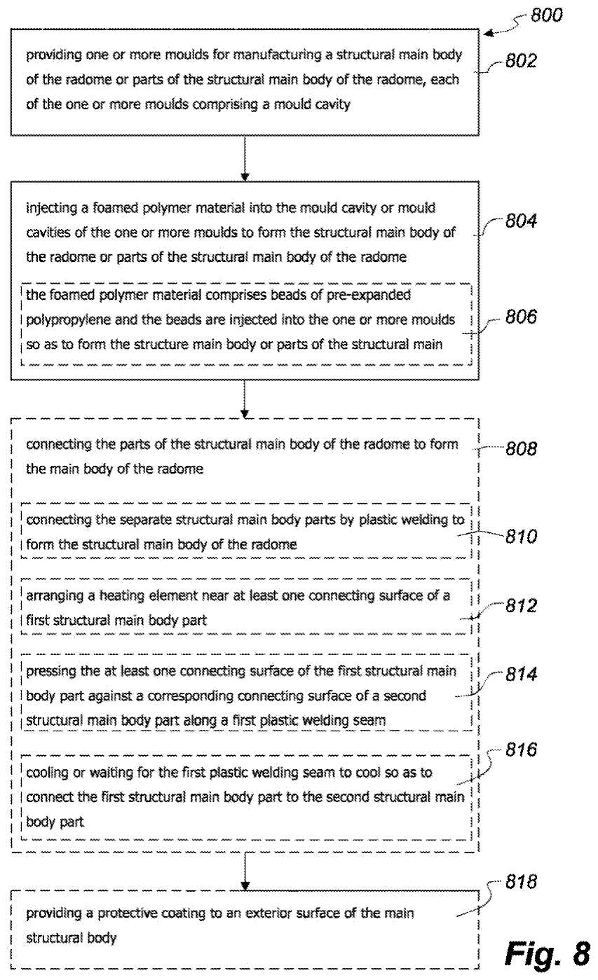

A method 900 of manufacturing a communication system is illustrated in FIG. 9. In a first step 902, a radome for encasing an antenna system for marine use according to method 800 is manufactured. In a second step 904, a platform is provided. In a third step 906, an antenna system is mounted on the platform. In a fourth step 908, the platform with the supported antenna system is connected to an open end of the radome.

### EXEMPLARY EMBODIMENTS

Exemplary embodiments of the present disclosure are set out in the following articles and items:

Article

1. A communication system, preferably for marine use, comprising:
a radome comprising a structural main body, which is made of a foamed polymer material, the radome further comprising an open proximal end,
a platform connected to the open proximal end of the radome, and
an antenna system mounted on the platform,
wherein the radome and platform are configured such that the radome encases the antenna system.

2. The communication system according to article 1, wherein the foamed polymer material is expanded polypropylene.

3. The communication system according to any of articles 1-2, wherein the foamed polymer material is a closed-cell foamed polymer material.

4. The communication system according to article 3, wherein the closed-cell foamed material is made from beads that are pre-expanded before the formation of the structural main body.

5. The communication system according to any of articles 1-4, wherein the structural main body has a shape with a proximal part which is substantially cylindrical or conical, and a distal part that is substantially spherical.

6. The communication system according to any of articles 1-5, wherein the structural main body is made from a plurality of separately manufactured parts that are subsequently connected to form the structural main body.

7. The communication system according to article 6, wherein the plurality of separately manufactured parts is connected by plastic welding, preferably by non-contact heating of connecting surfaces of the plurality of separately manufactured parts.

8. The communication system according to any of articles 6-7, wherein the separately manufactured parts are connected via plastic welding seams that have a thickness of 0.1-1.00 mm, preferably 0.2 mm-0.5 mm.

9. The communication system according to any of articles 6-8, wherein the structural main body is made from two half shells.

10. The communication system according to any of articles 6-9 and at least article 5, wherein the proximal part is made from a plurality of first parts, and at least a part of the distal part is made from a second part.

11. The communication system according to any of articles 1-10, wherein an exterior surface of the structural main body is coated with a protective coating, the protective coating forming an exterior surface of the radome.

12. The communication system according to article 11, wherein the protective coating is made from two or three layers, such as comprising an adhesion promoter layer or an adhesion promoter process, a primer layer and a topcoat layer, e.g., protective paint.

13. The communication system according to article 12, wherein the protective coating is made from at least two layers comprising a primer layer, and a topcoat layer combined with at least one of: surface activation of the structural main body, and an adhesion promoter layer.

14. The communication system according to article 13, wherein the surface activation of the structural main body is chosen from the group of: plasma treating, corona treating, and flame treating.

15. The communication system according to any of articles 11-14, wherein the protective coating, e.g., the protective paint, comprises a material chosen from the group of: polyurethane, and acrylic paint.

16. The communication system according to any of articles 11-15, wherein the protective coating has a thickness of 0.01-0.5 mm, preferably less than 0.3 mm.

17. The communication system according to any of articles 11-16, wherein the protective coating is transparent to radio waves in the range 0.5 GHz-120 GHz, preferably in the range 5-100 GHz, and more preferably in the range 10-45 GHz.

18. The communication system according of any of articles 1-17, wherein the structural main body has a thickness of 0.50 cm-10 cm, preferably 1.00 cm-5 cm.

19. The communication system according to any of articles 1-18, wherein the foamed polymer material has a density of 50-200 g/l.

20. The communication system according to any of articles 1-19, wherein the radome comprises a thickened portion at a proximal end of the structural main body.

21. The communication system according to article 20, wherein the thickened portion comprises a plurality of fastening members, the plurality of fastening members being configured to connect to attachment members for attaching a platform carrying the antenna system to the proximal end of the radome.

22. The communication system according to article 21, wherein the fastening members are made of a polymer material or a fibre-reinforced polymer material.

23. The communication system according to article 21-22, wherein the fastening members are friction welded into the thickened part of the radome.

24. The communication system according to any of articles 1-23, wherein the radome has a maximum outer dimension, such as a diameter of 0.50-4.0 m, preferably 0.50-3.0 m, and more preferably 0.50-2.0 m.

25. The communication system according to any of articles 1-24, wherein the platform is connected to fastening members arranged at the open proximal end of the radome via self-threading screws.

26. A radome for encasing an antenna system, preferably for marine use, wherein the radome comprises a structural main body, which is made from a foamed polymer material.

27. The radome according to article 26, wherein the foamed polymer material is expanded polypropylene.

28. The radome according to any of articles 26-28, wherein the foamed polymer material is a closed-cell foamed polymer material.

29. The radome according to article 28, wherein the closed-cell foamed material is made from beads that are pre-expanded before the formation of the structural main body.

30. The radome according to any of articles 26-29, wherein the structural main body has a shape with a proximal part which is substantially cylindrical or conical, and a distal part that is substantially spherical.

31. The radome according to any of articles 26-30, wherein the structural main body is made from a plurality of separately manufactured parts that are subsequently connected to form the structural main body.

32. The radome according to article 31, wherein the plurality of separately manufactured parts is connected by plastic welding, preferably by non-contact heating of connecting surfaces of the plurality of separately manufactured parts.

33. The radome according to any of articles 31-32, wherein the separately manufactured parts are connected via plastic welding seams that have a thickness of 0.1-1.00 mm, preferably 0.2 mm-0.5 mm.

34. The radome according to any of articles 31-33, wherein the structural main body is made from two half shells.

35. The radome according to any of articles 31-34 and at least article 32, wherein the proximal part is made from a plurality of first parts, and at least a part of the distal part is made from a second part.

36. The radome according to any of articles 26-35, wherein an exterior surface of the structural main body is coated with a protective coating, the protective coating forming an exterior surface of the radome.

37. The radome according to article 36, wherein the protective coating is made from two or three layers, such as comprising, an adhesion promoter layer or adhesion promoter process, a primer layer and a topcoat layer, e.g., protective paint.

38. The radome according to article 37, wherein the protective coating is made from at least two layers comprising a primer layer, and a topcoat layer combined with at least one of: surface activation of the structural main body, and an adhesion promoter layer.

39. The radome according to article 38, wherein the surface activation of the structural main body is chosen from the group of: plasma treating, corona treating, and flame treating.

40. The radome according to any of articles 36-39, wherein the protective coating, e.g., the protective paint, comprises a material chosen from the group of: polyurethane, and acrylic paint.

41. The radome according to any of articles 36-40, wherein the protective coating has a thickness of 0.01-0.5 mm, preferably less than 0.3 mm.

42. The radome according to any of articles 36-41, wherein the protective coating is transparent to radio waves in the range 0.5 GHz-120 GHz, preferably in the range 5-100 GHz, and more preferably in the range 10-45 GHz.

43. The radome according of any of articles 26-42, wherein the structural main body has a thickness of 0.50 cm-10 cm, preferably 1.00 cm-5 cm.

44. The radome according to any of articles 26-43, wherein the foamed polymer material has a density of 50-200 g/l.

45. The radome according to any of articles 26-44, wherein the radome comprises a thickened portion at a proximal end of the structural main body.

46. The radome according to article 45, wherein the thickened portion comprises a plurality of fastening members, the plurality of fastening members being configured to connect to attachment members for attaching a platform carrying the antenna system to the proximal end of the radome.

47. The radome according to article 46, wherein the fastening members are made of a polymer material or a fibre-reinforced polymer material.

48. The radome according to article 46-47, wherein the fastening members are friction welded into the thickened part of the radome.

49. The radome according to any of articles 26-48, wherein the radome has a maximum outer dimension, such as a diameter of 0.50-4.0 m, preferably 0.50-3.0 m, and more preferably 0.50-2.0 m.

50. A communication system comprising:
a radome according to any of articles 26-49, the radome comprising an open proximal end,
a platform connected to the open proximal end of the radome, and
an antenna system mounted on the platform.

51. Kit of parts comprising a plurality of separately manufactured structural main body parts made from a foamed polymer material, and which can be connected to form a structural main body of a radome according to any of articles 26-49.

52. A method of manufacturing a radome for encasing an antenna system, preferably for marine use, the method comprising the steps of:
providing one or more moulds for manufacturing a structural main body of the radome or parts of the structural main body of the radome, each of the one or more moulds comprising a mould cavity,
injecting a foamed polymer material into the mould cavity or mould cavities of the one or more moulds to form the structural main body of the radome or parts of the structural main body of the radome, and
optionally connecting the parts of the structural main body of the radome to form the main body of the radome.

53. The method according to article 52, wherein the foamed polymer material comprises beads of pre-expanded polypropylene and the beads are injected into the one or more moulds so as to form the structural main body or parts of the structural main body of the radome as a closed-cell foamed polymer.

54. The method according to any of articles 52-53, wherein the method comprises the steps of:

manufacturing a plurality of separate structural main body parts made from foamed polymer, and

connecting the separate structural main body parts by plastic welding to form the structural main body of the radome.

55. The method according to article 54, wherein the separate structural main body parts are connected to each other by non-contact heating of connecting surfaces.

56. The method according to article 55, wherein the method comprises the steps of:

arranging a heating element near at least one connecting surface of a first structural main body part and a heating element near at least a corresponding connecting surface of a second structural body,

pressing the at least one connecting surface of the first structural main body part against the corresponding connecting surface of the second structural main body part along a first plastic welding seam, and

cooling or waiting for the first plastic welding seam to cool so as to connect the first structural main body part to the second structural main body part, and

optionally repeating the steps to form the structural main body.

57. The method according to any of articles 52-56, wherein the method comprises the steps of:

applying a protective coating onto an exterior surface of the main body.

58. The method according to article 57, wherein the step of applying a protective coating onto an external surface of the main body comprises:

applying a primer layer, and

applying a topcoat layer, e.g., protective pain, such as polyurethane and acrylic paint.

59. The method according to article 58, wherein the step of applying a protective coating onto an external surface of the structural main body comprises: applying an adhesion promoter layer prior to applying the primer layer.

60. The method according to any of articles 58-59, wherein the step of applying a protective coating onto an external surface of the main body comprises: surface activating the exterior surface of the structural main body.

61. The method according to article 60, wherein surface activating the exterior surface of the structural main body comprises at least one of: plasma treating, corona treating, and flame treating the exterior surface of the structural main body.

62. The method according to any of articles 57-61, wherein the exterior surface of the main body is surface abraded before applying the protective coating, and preferably the exterior surface is cleaned after the step of mechanically abrading the exterior surface of the main body.

63. The method according to any of articles 58-62, wherein the primer layer is surface abraded before applying the topcoat layer.

64. A method of manufacturing a communication system, the method comprising the steps of:
manufacturing a radome for encasing an antenna system for marine use according to any of the method of articles 62-63,
providing a platform,
mounting an antenna system on the platform, and
connecting the platform to an open end of the radome.

### Item

1. A radome for encasing an antenna system, preferably for marine use, wherein the radome comprises a structural main body, which is made from a foamed polymer material.

2. The radome according to item 1, wherein the foamed polymer material is expanded polypropylene.

3. The radome according to any of items 1-2, wherein the foamed polymer material is a closed-cell foamed polymer material.

4. The radome according to item 3, wherein the closed-cell foamed material is made from beads that are pre-expanded before the formation of the structural main body.

5. The radome according to any of items 1-4, wherein the structural main body has a shape with a proximal part which is substantially cylindrical or conical, and a distal part that is substantially spherical.

6. The radome according to any of items 1-5, wherein the structural main body is made from a plurality of separately manufactured parts that are subsequently connected to form the structural main body.

7. The radome according to item 6, wherein the plurality of separately manufactured parts is connected by plastic welding, preferably by non-contact heating of connecting surfaces of the plurality of separately manufactured parts.

8. The radome according to any of items 6-7, wherein the separately manufactured parts are connected via plastic welding seams that have a thickness of 0.1-1.00 mm, preferably 0.2 mm-0.5 mm.

9. The radome according to any of items 6-8, wherein the structural main body is made from two half shells.

10. The radome according to any of items 6-9 and at least item 5, wherein the proximal part is made from a plurality of first parts, and at least a part of the distal part is made from a second part.

11. The radome according to any of items 1-10, wherein an exterior surface of the structural main body is coated with a protective coating, the protective coating forming an exterior surface of the radome.

12. The radome according to item 11, wherein the protective coating is made from two or three layers, such as comprising an adhesion promoter layer, a primer layer, and a topcoat layer, e.g., protective paint.

13. The radome according to item 11, wherein the protective coating, e.g., the protective paint, comprises a material chosen from the group of: polyurethane, and acrylic paint.

14. The radome according to any of items 11-12, wherein the protective coating has a thickness of 0.01-0.5 mm, preferably less than 0.3 mm.

15. The radome according to any of items 11-14, wherein the protective coating is transparent to radio waves in the range 0.5 GHz-120 GHz, preferably in the range 5-100 GHz, and more preferably in the range 10-45 GHz.

16. The radome according of any of items 1-15, wherein the structural main body has a thickness of 0.50 cm-10 cm, preferably 1.00 cm-5 cm.

17. The radome according to any of items 1-16, wherein the foamed polymer material has a density of 50-200 g/l.

18. The radome according to any of items 1-17, wherein the radome comprises a thickened portion at a proximal end of the structural main body.

19. The radome according to item 17, wherein the thickened portion comprises a plurality of fastening members, the plurality of fastening members being configured to connect to attachment members for attaching a platform carrying the antenna system to the proximal end of the radome.

20. The radome according to item 19, wherein the fastening members are made of a polymer material or a fibre-reinforced polymer material.

21. The radome according to item 19-20, wherein the fastening members are friction welded into the thickened part of the radome.

22. The radome according to any of items 1-21, wherein the radome has a maximum outer dimension, such as a diameter of 0.50-4.0 m, preferably 0.50-3.0 m, and more preferably 0.50-2.0 m.

23. A communication system comprising:
a radome according to any of items 1-22, the radome comprising an open proximal end,
a platform connected to the open proximal end of the radome, and
an antenna system mounted on the platform.

24. The communication system according to item 23, wherein the platform is connected to fastening members arranged at the open proximal end of the radome via self-threading screws.

25. Kit of parts comprising a plurality of separately manufactured structural main body parts made from a foamed polymer material, and which can be connected to form a structural main body of a radome according to any of items 1-22.

26. A method of manufacturing a radome for encasing an antenna system, preferably for marine use, the method comprising the steps of:
providing one or more moulds for manufacturing a structural main body of the radome or parts of the structural main body of the radome, each of the one or more moulds comprising a mould cavity,
injecting a foamed polymer material into the mould cavity or mould cavities of the one or more moulds to form the structural main body of the radome or parts of the structural main body of the radome, and
optionally connecting the parts of the structural main body of the radome to form the main body of the radome.

27. The method according to item 26, wherein the foamed polymer material comprises beads of pre-expanded polypropylene and the beads are injected into the one or more moulds so as to form the structural main body or parts of the structural main body of the radome as a closed-cell foamed polymer.

28. The method according to any of items 26-27, wherein the method comprises the steps of:
manufacturing a plurality of separate structural main body parts made from foamed polymer, and
connecting the separate structural main body parts by plastic welding to form the structural main body of the radome.

29. The method according to item 28, wherein the separate structural main body parts are connected to each other by non-contact heating of connecting surfaces.

30. The method according to item 29, wherein the method comprises the steps of:
arranging a heating element near at least one connecting surface of a first structural main body part and a heating element near at least a corresponding connecting surface of a second structural body,
pressing the at least one connecting surface of the first structural main body part against the corresponding connecting surface of the second structural main body part along a first plastic welding seam, and
cooling or waiting for the first plastic welding seam to cool so as to connect the first structural main body part to the second structural main body part, and
optionally repeating the steps to form the structural main body.

31. A method of manufacturing a communication system, the method comprising the steps of:
manufacturing a radome for encasing an antenna system for marine use according to any of the method of items 26-30,
providing a platform,
mounting an antenna system on the platform, and
connecting the platform to an open end of the radome.

List of reference numerals

| | |
|---|---|
| 100, 200, 300, 400, 500, 600, 600′, 700 | Radome |
| 110, 210, 310, 410, 510, 610, 610′ | Structural main body |
| 110a, 110b, 210a, 210b, 210c, 210d, 310a, | Structural main body parts |
| 310b, 310c, 310d, 310e | |
| 112, 412 | Proximal part |
| 114, 414 | Distal part |
| 116, 416 | Open end |
| 118, 418, 518, 618, 618′ | Thickened portion |
| 120, 420 | Fastening members |
| 422 | Connecting members |
| 550, 650, 650′, 750 | Communication system |
| 560, 660, 660′, 760 | Platform |
| 570, 670, 670′ | Antenna system |
| 800, 900 | Methods |
| 802, 804, 806, 808, 810, 812, 814, 816, 818, | Method steps |
| 902, 904, 906, 908 | |

64. (canceled)

65. A communication system, preferably for marine use, comprising:
a radome comprising a structural main body, which is made of a foamed polymer material, the radome further comprising an open proximal end,
a platform connected to the open proximal end of the radome, and
an antenna system mounted on the platform,
wherein the radome and platform are configured such that the radome encases the antenna system.

66. The communication system according to claim 65, wherein the foamed polymer material is a closed-cell foamed polymer material made of expanded polypropylene.

67. The communication system according to claim 65, wherein the structural main body has a shape with a proximal part which is substantially cylindrical or conical, and a distal part that is substantially spherical.

68. The communication system according to claim 65, wherein the structural main body is made from two half shells.

69. The communication system according to claim 65, wherein the proximal part is made from a plurality of first parts, and at least a part of the distal part is made from a second part.

70. The communication system according to claim 65, wherein an exterior surface of the structural main body is coated with a protective coating, the protective coating forming an exterior surface of the radome.

71. The communication system according to claim 70, wherein the protective coating is made from two or three layers, such as comprising an adhesion promoter layer or an adhesion promoter process, a primer layer and a topcoat layer, e.g., protective paint.

72. The communication system according to claim 71, wherein the protective coating is made from at least two layers comprising a primer layer, and a topcoat layer combined with at least one of: surface activation of the structural main body, and an adhesion promoter layer.

73. The communication system according to claim 65, wherein the radome comprises a thickened portion at a proximal end of the structural main body, wherein the thickened portion comprises a plurality of fastening members, the plurality of fastening members being configured to connect to attachment members for attaching a platform carrying the antenna system to the proximal end of the radome.

74. The communication system according to claim 73, wherein the fastening members are made of a polymer material or a fibre-reinforced polymer material.

75. The communication system according to claim 73, wherein the fastening members are friction welded into the thickened part of the radome.

76. A radome for encasing an antenna system, preferably for marine use, wherein the radome comprises a structural main body, which is made from a foamed polymer material.

77. The radome according to claim 76, wherein the foamed polymer material is a closed-celled foamed material made of expanded polypropylene.

78. A method of manufacturing a radome for encasing an antenna system, preferably for marine use, the method comprising the steps of:
providing one or more moulds for manufacturing a structural main body of the radome or parts of the structural main body of the radome, each of the one or more moulds comprising a mould cavity,
injecting a foamed polymer material into the mould cavity or mould cavities of the one or more moulds to form the structural main body of the radome or parts of the structural main body of the radome, and
optionally connecting the parts of the structural main body of the radome to form the main body of the radome.

79. The method according to claim 78, wherein the foamed polymer material comprises beads of pre-expanded polypropylene and the beads are injected into the one or more moulds so as to form the structural main body or parts of the structural main body of the radome as a closed-cell foamed polymer.

80. The method according to claim 78, wherein the method comprises the steps of:
manufacturing a plurality of separate structural main body parts made from foamed polymer, and
connecting the separate structural main body parts by plastic welding to form the structural main body of the radome.

81. The method according to claim 80, wherein the separate structural main body parts are connected to each other by non-contact heating of connecting surfaces, wherein the method comprises the steps of:
arranging a heating element near at least one connecting surface of a first structural main body part and a heating element near at least a corresponding connecting surface of a second structural body,
pressing the at least one connecting surface of the first structural main body part against the corresponding connecting surface of the second structural main body part along a first plastic welding seam, and
cooling or waiting for the first plastic welding seam to cool so as to connect the first structural main body part to the second structural main body part, and
optionally repeating the steps to form the structural main body.

82. The method according to claim 78, wherein the method comprises the steps of:
applying a protective coating onto an exterior surface of the main body, wherein the step of applying a protective coating onto an external surface of the main body comprises:
applying a primer layer, and
applying a topcoat layer, e.g., protective pain, such as polyurethane and acrylic paint.

83. The method according to claim 82, wherein the step of applying a protective coating onto an external surface of the structural main body comprises:
applying an adhesion promoter layer prior to applying the primer layer.

84. The method according to claim 82, wherein the step of applying a protective coating onto an external surface of the main body comprises:
surface activating the exterior surface of the structural main body.
